(19) United States
(12) Patent Application Publication
(10) Pub. No.: US 2025/0118906 A1
(43) Pub. Date: Apr. 10, 2025

(54) CONTACT HOOK AND CONTACT ARRANGEMENT FOR PROVIDING AN ELECTRIC CONTACT TO A WINDING ARRANGEMENT OF AN ELECTRIC MACHINE AND METHOD OF PRODUCING A CONTACT ARRANGEMENT

(71) Applicant: AUDI AG, Ingolstadt (DE)

(72) Inventors: Martin GERNGROß, Kinding (DE); Patrick HERRMANN, Pfaffenhofen (DE); Lars WETTERAU, Ingolstadt (DE)

(73) Assignee: AUDI AG, Ingolstadt (DE)

(21) Appl. No.: 18/822,663

(22) Filed: Sep. 3, 2024

(30) Foreign Application Priority Data
Oct. 10, 2023 (DE) 102023127577.1

(51) Int. Cl. H01R 4/02; H01R 43/02

(52) U.S. Cl. CPC H01R 4/029; H01R 43/0214; H01R 2201/10

(57) ABSTRACT

A contact hook for providing an electric contact to a winding arrangement of an electric machine, with a fastening portion for fastening to the electric machine, which provides a first contact surface for a resistance welding electrode, and a hook portion adjoining the fastening portion, which provides a second contact surface for a resistance welding electrode. The hook portion is formed and arranged for forming with the fastening portion a groove for receiving a wire connected to the winding arrangement in a first assembly state, in which a free end of the hook portion forms, at a distance from the fastening portion, a groove opening for inserting the wire into the groove. The free end of the hook portion in a second assembly state rests against the fastening portion, closing the groove opening.

### FIELD

The invention relates to a contact hook and a contact arrangement for providing an electric contact to a winding arrangement of an electric machine. The invention also relates to a method for producing a contact arrangement.

### BACKGROUND

The active part of an electric machine basically consists of a stationary part, the stator, and a moving part, the rotor. The stator contains conductors that generate a rotating magnetic field by applying a suitable current. Through electromagnetic interaction with the rotor, the stator exerts a force on the rotor, causing it to move. There are different machine principles for this. The most common are asynchronous machines (ASM for short), permanently excited synchronous machines (PSM for short) and externally excited synchronous machines (FSM for short).

The externally excited synchronous machine (FSM) is a magnetless alternative to the permanently excited synchronous machine (PSM) for driving an electrified vehicle. The magnets in the rotor of the PSM are replaced by current-carrying copper windings, which as an electromagnet generate the torque-generating rotor magnetic field.

The copper windings of the rotor consist of a standard enameled wire. These windings are wound onto the rotor poles. For reasons of efficiency and performance, an attempt is made to wind as many turns as possible in the available cross-sectional area. For this reason, an orthocyclic winding is targeted, as this allows the highest possible packing density due to the 60° offset between wires of two layers.

The winding body of an FSM rotor is made up of several components. The central component is the sheet metal packet mounted on a shaft. After winding, the copper wires run in the grooves of the sheet metal packet. To deflect the wire coils in the region of the winding heads, two star disks are fastened to the end faces of the sheet metal packet. The star disks have a contour for targeted mechanical support of the wire coils. The star disks can be made entirely of plastic. A metal core can also be used to increase the strength. The metal base body of such components is overmolded with plastic.

The winding of the rotor consists of concentrated coils, each of which is arranged around the poles. As a rule, the rotor has six poles, but there can also be a different number of poles, e.g. eight poles. The design is based on a trapezoidal winding structure in order to fill the space between the poles with copper as much as possible. This makes it possible to achieve a high degree of copper filling and thus a high efficiency and power density of the electric machine. All the partial windings shown are built up in series with a continuous wire.

The challenge with a trapezoidal winding structure is that the last turn of a pole winding never ends at the bottom of the yoke. However, it is only ever possible to change between the poles at the bottom of the yoke. The first winding is at the bottom of the yoke. The winding then builds up in layers. The last winding ends at the top of the pole piece and not at the bottom of the yoke. However, it is only ever possible to change between the poles at the bottom of the yoke. As the poles can only be changed at the bottom, the wire must be led back to the yoke. From the point of view of the rotor, the return is from radially outside to inside in the direction of the shaft. The individual poles can then be connected at the yoke.

There are various approaches for returning the wire from the pole piece to the yoke:

On the one hand, there is the option of return via special contours in the star disk. These support the wire and allow it to run diagonally across the winding head. The exact implementation is described in the German patent application DE 10 2020 118 944.

Secondly, the wire can be fed back from the pole piece to the yoke using a special winding scheme. Specific gaps or spaces in the winding support the wire as it is fed back. The exact implementation is described in German patent application DE 10 2021 101 814.

In both variants, the last winding is positioned directly on the yoke.

The German patent application DE 10 2021 122 066 describes an alternative procedure for returning the wire. The core idea is the integration of busbars for conductor return in trapezoidal windings in the star disk. The busbars are cast into the star disc, for example using an injection molding process. The conductor is then no longer returned from the pole piece to the yoke via standard winding wire, as is the case with all other windings, but via a busbar. The return function is therefore shifted to the star disk. The busbars are embedded in injection-molded plastic (“overmolding”). There are contacting elements at both ends of the busbars, each of which creates a connection between the winding and the busbar. The star disk can also include a metal core. The overmolding also includes the function of wire guidance and wire support. The specifically defined outer contour enables a robust winding process. Fork-shaped contacting elements, also known as fork contacts, are used as the transition between a wound wire coil and the busbars.

The fork contacts pose a problem, particularly when the rotor is wound automatically, e.g. using needle winding technology, because the wire cannot be inserted automatically without further ado. The reason for this is the tensile forces that act on the outside, especially in the position on the star disk.

To ensure that the contact is as mechanically stable as possible, the wire must always lie in the groove base of the fork contact. During winding, the wire is subjected to a so-called wire tensile force that acts in the direction of the wire. This force always produces a run-out contour at the exit of the wire from a winding needle, which in simplified terms corresponds to a circular arc with a radius that depends on the wire tension. In order to be able to lay the wire safely in the groove base, it must be laid in a constrained position that results in a wire exit angle of greater than 90° between the winding needle and the wire emerging from it. However, this angle leads to impermissibly high wire tensile forces, which can damage the wire or even lead to wire breakage. These constrained positions require the fork contact to be axially higher than a support contour. However, this additional installation space is not magnetically active and reduces the power density of the drive.

DE 10 2017 214 776 A1 describes a method for producing a rotor for an electric machine with a contactless power transmission system, wherein a winding head cover is arranged on one end face of a sheet metal packet of the rotor. A secondary unit (SEC) of the power transmission system is integrated into the winding head cover and, as a result, the secondary unit (SEC) is held on the rotor indirectly via the winding head cover after the winding head cover has been arranged. An excitation winding of the rotor is connected to a contact element of a rectifier of the secondary unit, wherein the contact element is designed as a winding hook, which is plugged into a rectifier board of the rectifier with a rear fastening portion. A hook portion of the winding hook extends in the axial direction of the rotor.

CN 207117332 U discloses a rotor assembly with a winding arrangement in which connections of the winding arrangement are fastened by ultrasonic welding to an inner side of a hook, which in turn is fastened to a commutator unit.

DE 10 2015 001 096 A1 relates to a stator of an electric motor with a multiphase stator winding with a number of coils with respective first and second coil ends for each phase, and with a switching unit with a number of contact wires which have a number of bent contact hooks with spaced-apart opposite wire legs to form a connection opening for connecting these respectively assigned coil ends, which receives the associated coil end, the contact wire being designed as a round wire and being embossed flat in the region of the contact hooks on the outer side of the wire legs facing away from the connection opening, forming planar contact surfaces for a welding electrode.

### SUMMARY

Against this background, the object of the invention is to provide devices and methods that can be used to simplify the production of electric machines, in particular externally excited synchronous machines, with high efficiency and power density. In addition, the electric machines should have a compact design.

This object is achieved by a contact hook, by a contact arrangement and by a method for producing a contact arrangement.

It should be noted that the features listed individually in the claims can be combined with each other in any technically meaningful way (also across category boundaries, for example between method and device) and show further embodiments of the invention. The description additionally characterizes and specifies the invention, in particular in connection with the figures.

It should also be noted that a conjunction “and/or” used herein between two features and linking them together should always be interpreted such that in a first embodiment of the subject-matter according to the invention only the first feature may be present, in a second embodiment only the second feature may be present and in a third embodiment both the first and the second feature may be present.

The subject of the invention is a contact hook for providing an electric contact to a winding arrangement of an electric machine, such as an externally excited synchronous machine (FSM). The contact hook has a fastening portion for fastening to the electric machine, which provides a first contact surface for a resistance welding electrode, and a hook portion adjoining the fastening portion, which provides a second contact surface for a resistance welding electrode. The hook portion is designed and arranged to form a groove with the fastening portion for receiving a wire connected to the winding arrangement in a first assembly state, in which a free end of the hook portion forms a groove opening at a distance from the fastening portion for inserting the wire into the groove, wherein the free end of the hook portion rests against the fastening portion in a second assembly state, closing the groove opening, in such a way that the first contact surface and the second contact surface run plane-parallel to one another.

The hook portion is to be understood as a curved or angularly curved portion for hooking the wire. The groove is to be understood as an elongated depression that is delimited by the hook portion and the fastening portion. The hook portion is connected to the fastening portion. The fastening portion serves to fasten the contact hook to the electric machine, wherein this comprises fastening to a component of the electric machine, e.g. a rotor, a star disk of the rotor, a stator and the like.

A wire is a thin and long, flexible metal, preferably with a circular cross-section. Other cross-sectional shapes are known from flat, square or profiled wires.

In contrast to U-shaped or fork-shaped contacting elements from the prior art, which have two free legs, the hook portion of the present contact hook only has one free leg, which forms one side of the groove. The opposite side of the groove is formed by the fastening portion.

Since the first and second contact surfaces run plane-parallel in the second assembly state, i.e. the surfaces run flat and parallel to each other, a parallel arrangement of resistance welding electrodes in contact with the contact surfaces is possible. The parallel arrangement of the welding electrodes in relation to each other refers to an essentially parallel course of the respective longitudinal axes of the electrodes. This enables a compact, space-saving arrangement of the electrodes for resistance welding the contact hook or the hook portion to the fastening portion in order to achieve an electrically conductive connection of the wire (e.g. an enameled wire coated with an electrically insulating enamel) to the contact hook.

It should be noted that a slight deviation from an exact (i.e. ideal) parallelism of the two welding electrodes and a slight deviation from an exact (i.e. ideal) plane parallelism of the first and second contact surfaces should each be covered by the invention within a tolerance range which the skilled person working in the present field considers to be customary. This is to be understood as a tolerance range of the relevant size with a deviation from an ideal size up to a maximum of +/−20%, preferably up to a maximum of +/−10%.

Furthermore, the second assembly state obtained by closing the groove opening creates an additional crimping effect on the wire inserted into the groove.

In the first assembly state, wrapping the wire in the contact hook (e.g. using a needle winding technique) is significantly simplified compared to the prior art—for example a fork contact—as will be explained in more detail herein.

In a preferred embodiment, the first contact surface and the second contact surface are provided on the same side of the contact hook. Accordingly, the resistance welding electrodes can be brought parallel to each other from the same side to the respective contact surfaces and applied. This enables an even more compact arrangement of the resistance welding electrodes in order to make an electrically conductive connection between the contact hook and the wire inserted into the groove. The second contact surface can be provided on an outer side of the hook portion.

In further preferred embodiments, the groove runs from the groove opening to a groove base at an angle to the first contact surface. This allows the wire to lie lower at the base of the groove than the first contact surface, so that the hook portion runs plane-parallel to the first contact surface in the second assembly state despite its free end resting on the fastening portion. In addition, the inclined groove allows the wire to slide reliably into the groove and results in robust support at the base of the groove.

In advantageous embodiments, the first contact surface also forms a support surface for the wire in order to lay the wire in front of the groove opening in the first assembly state. When using a needle winding technique, the wire has a certain bending slackness after emerging from a winding needle and bends to varying degrees depending on various factors, e.g. the wire tension. In the present case, the wire can slide laterally along the groove opening along the first contact surface or support surface. This means that the wire is pre-positioned on the support surface and its bending slack does not play a role during laying. This makes it much easier for it to hit the groove and be inserted into the groove.

In further advantageous embodiments, the groove has a uniform diameter in the first assembly state, i.e. the diameter of the groove is essentially the same from the groove opening to a groove base. In this way, the wire is reliably guided by the surfaces delimiting the groove when it is inserted into the groove, so that it ultimately always comes to rest in the groove base without having to use a constrained position for this purpose. This means that a wire exit angle between a winding needle and the wire emerging from it can advantageously always be less than 90°.

In still further preferred embodiments, an undercut is provided in a transition region between the fastening portion and the hook portion. This can, for example, be incorporated into the contact hook on an outer side. Among other things, it reliably prevents the formation of stress cracks.

It is further an object of the invention to provide a contact arrangement for providing an electric contact to a winding arrangement of an electric machine or a component of the electric machine, such as a rotor, a star disk of the rotor, a stator and the like. The contact arrangement has a contact hook according to one of the embodiments disclosed herein and a wire connecting the contact hook to the winding arrangement.

It is to be understood that with regard to arrangement-related definitions of terms and the effects and advantages of arrangement-related features, full reference can be made to the disclosure of analogous definitions, effects and advantages of the contact hook according to the invention and vice versa. A repetition of explanations of correspondingly identical features, their effects and advantages can thus be dispensed with in favor of a more compact description, without such omissions having to be interpreted as a limitation for one of the disclosed subject matters of the invention.

In preferred embodiments, the winding arrangement is a winding arrangement of a rotor (i.e. a rotor winding) of the electric machine, wherein the contact hook is fastened to a star disk of the rotor and establishes an electrically conductive connection to the rotor winding.

In other embodiments, the winding arrangement is a winding arrangement of a stator (i.e. stator winding) of the electric machine, wherein the contact hook is fastened to the stator and establishes an electrically conductive connection to the stator winding.

In still further advantageous embodiments, a support contour is provided adjacent to the contact hook to support the wire, wherein the contact hook does not protrude beyond the support contour in its second assembly position. This enables an even more compact design of the contact arrangement. If the contact hook is fastened to an end face of a star disk of a rotor, for example, the required axial installation space for the rotor can be reduced to a minimum, which increases the power density of the electric machine, as less magnetically inactive volume of the machine has to considered.

It is further an object of the invention to provide a method of producing a contact arrangement according to any one of the embodiments disclosed herein. The method comprises the steps of:
providing the contact hook according to one of the embodiments disclosed herein in its first assembly state,
inserting the wire into the groove of the contact hook using a winding needle,
pulling the wire into a groove base of the groove,
providing the second assembly state of the contact hook by bending the hook portion so that the free end of the hook portion rests against the fastening portion and the first contact surface and the second contact surface run plane-parallel to each other,
contacting a first resistance welding electrode with the first contact surface,
contacting a second resistance welding electrode with the second contact surface and
resistance welding the hook portion to the fastening portion using the first and second resistance welding electrodes to produce an electrically conductive connection between the wire and the contact hook.

The disclosure of analogous definitions, effects and advantages of the contact hook or contact arrangement according to the invention can also be fully referred to with regard to method-related definitions of terms and the effects and advantages of features according to the invention, and vice versa.

### BRIEF DESCRIPTION OF THE FIGURES

Further features and advantages of the invention are apparent from the following description of non-limiting exemplary embodiments of the invention, which will be explained in more detail below with reference to the drawing. In this drawing, schematically:

FIG. 1 shows a side view of a contact hook according to one embodiment of the invention;

FIG. 2 shows a side view and a top view of the contact hook of FIG. 1 to illustrate a method of producing a contact arrangement according to an embodiment of the invention;

FIG. 3 shows a first side view of the contact hook from FIG. 1 in a first assembly state of a contact arrangement according to an embodiment of the invention and a second side view of the contact hook in a second assembly state;

FIG. 4 shows a side view of the contact arrangement of FIG. 3 to illustrate a resistance welding process; and

FIG. 5 shows a perspective view of a rotor of an electric machine with the contact arrangement from FIG. 3.

### DETAILED DESCRIPTION

In the various figures, parts that are equivalent in terms of their function are always provided with the same reference numerals so that they are generally only described once.

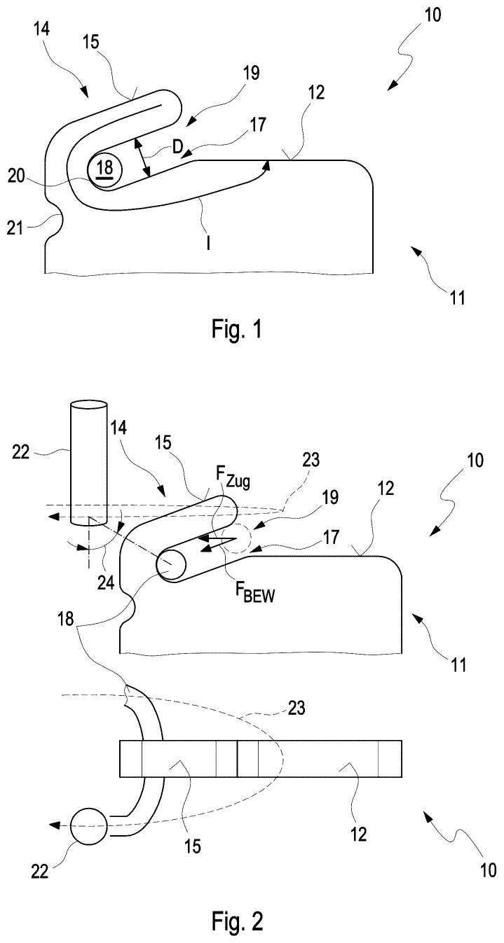

FIG. 1 schematically represents a side view of a contact hook 10 according to an embodiment of the invention for providing an electric contact to a winding arrangement of an electric machine (both not shown).

FIG. 1 shows that the contact hook 10 has a fastening portion 11 for fastening to the electric machine or a machine component such as the rotor, star disk of the rotor, stator, etc., wherein the fastening portion 11 provides a first contact surface 12 for a first resistance welding electrode 13 (see FIG. 4). A hook portion 14 adjoins the fastening portion 11, which hook portion provides a second contact surface 15 for a second resistance welding electrode 16 (see FIG. 4). The hook portion 14 is materially connected to the fastening portion 11.

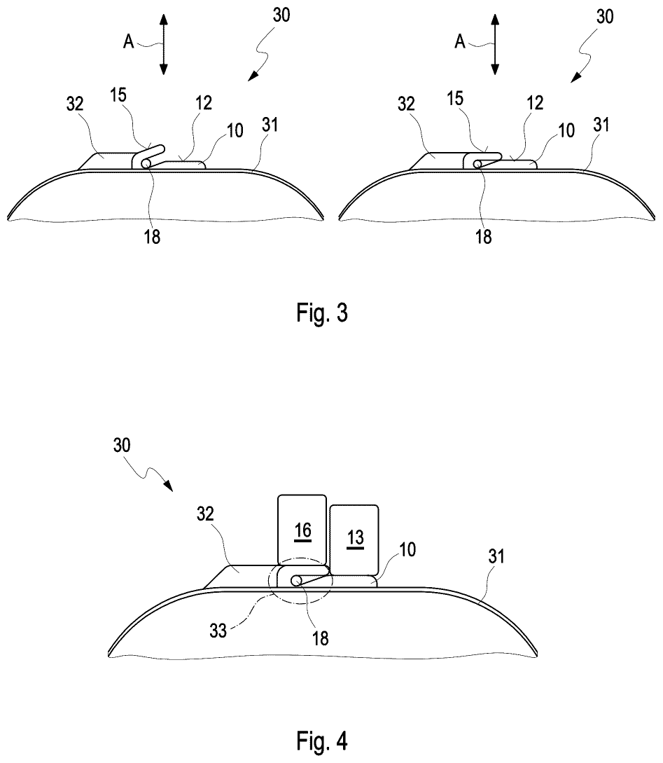

As can further be seen from FIG. 1, the hook portion 14 is designed and arranged to form a groove 17 with the fastening portion 11 for receiving a wire 18 connected to the winding arrangement in a first assembly state shown in FIG. 1, in which a free end of the hook portion 14 forms a groove opening 19 at a distance from the fastening portion 11 for inserting the wire 18 into the groove 17. In a second assembly state of the contact hook 10, which is shown in FIG. 3, the free end of the hook portion 14 rests against the fastening portion 11 in such a way that it closes the groove opening 19. In the second assembly state, the first contact surface 12 and the second contact surface 15 run plane-parallel to each other.

In the exemplary embodiment of the contact hook 10 shown in FIG. 1, the first contact surface 12 and the second contact surface 15 are provided on the same side of the contact hook 10 (in the present case an upper side).

Furthermore, it can be seen in FIG. 1 that the groove 17 runs from the groove opening 19 to a groove base 20 at an angle to the first contact surface 12.

In addition, the groove 17 of the present contact hook 10 has a uniform diameter D from the groove opening 19 to the groove base 20 in the first assembly state, but is not necessarily limited to this. The diameter D of the groove 17 can also be larger than a wire diameter at the groove opening 19 and essentially reduce to the wire diameter at the groove base 20. In any case, the diameter D of the groove 17 is selected so that it is always slightly larger than the wire diameter of the wire 18 to be inserted in order to ensure easy sliding of the wire 18 into the groove 17.

FIG. 1 also shows that the contact hook 10 shown has an undercut 21 in a transition region between the fastening portion 11 and the hook portion 14, without being limited to this.

FIG. 2 schematically depicts a side view (upper view) and a top view (lower view) of the contact hook 10 of FIG. 1 for explaining a method for producing a contact arrangement 30, as shown for example in FIG. 3, according to an embodiment of the invention, by means of a needle winding technique.

After the contact hook 10 is provided in its first assembly state, the wire 18 is inserted into the groove 17 by means of a winding needle 22. For this purpose, the winding needle 22 moves along a movement path 23 (dashed line) shown in FIG. 2 relative to the contact hook 10. Due to the special design of the contact hook 10, which is open on one side, in its first assembly state together with the groove 17, which runs at an angle to the first contact surface 12, which in the present case also provides a support surface for the wire 18, the wire 18 is laid in the groove opening 19 (dashed wire 18) and acted upon by the wire tensile force F_{Zug} applied by the winding needle 22. At the groove opening 19, the tensile force F_{Zug} results in a movement force component F_{Bew} parallel to the groove 17, which sets the wire 18 in motion and allows it to slide through the groove opening 19 to the groove base 20. This force component F_{Bew} guarantees that the wire 18 is always in the same position in the groove base 20, which has a very beneficial effect on the subsequent resistance welding process. Another significant advantage of the contact hook 10 is that a wire exit angle 24 of 90° is not exceeded at any time while the wire 18 is laid on the groove base 20. The wire exit angle 24 is always less than 90°.

A further advantage of the contact hook 10 shown is the improved winding capability despite the naturally existing component and/or movement tolerances of the winding needle. As already mentioned, the wire 18 has a certain bending slackness after exiting the winding needle 22 and bends to varying degrees depending on various factors, e.g. the wire tension, wire diameter, etc. In the present contact hook 10, the wire 18 can slide laterally along the groove opening 19 along the first contact surface 12 serving as a support surface. This means that the wire 18 is pre-positioned on that support surface and its bending slack is irrelevant when it is laid. This makes it much easier to meet the groove 17 precisely.

After the wire 18 has been laid at the groove base 20, the second assembly state (see right-hand view of FIG. 3) of the contact hook 10 is produced by bending the hook portion 14 (e.g. by means of a punch) so that the free end of the hook portion 14 rests against the fastening portion 11 and the first contact surface 12 and the second contact surface 15 run plane-parallel to one another.

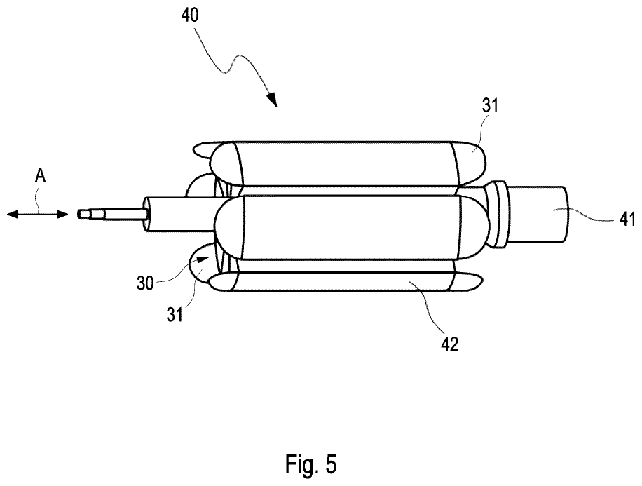

FIG. 3 schematically depicts a first side view (left view) of the contact hook 10 of FIG. 1 in its first assembly state of a contact arrangement 30 according to an embodiment of the invention for providing an electric contact to a winding arrangement of an electric machine (both not shown) and a second side view (right view) of the contact hook 10 in its second assembly state. In the example shown here, the contact hook 10 is fastened to a star disk 31 of a rotor 40 (see FIG. 5) of the electric machine. Only part of the star disk 31 is shown in FIG. 3, namely an axial end portion of the star disk 31.

An axial direction A of the star disk 31 attached to the rotor 40 is shown in FIG. 3. The wire 18 electrically connects the contact hook 10 to the winding arrangement, which is a rotor winding in the present case. In the contact arrangement 30 shown in FIG. 3, a support contour 32 is located adjacent to the contact hook 10 on the star disk 31 to support the wire 18.

In the first assembly state (left view in FIG. 3) of the contact hook 10, i.e. in the not welded state, the contact hook 10 still protrudes in axial direction A beyond the axial end of the star disk 31 or beyond the support structure 32. After the welding process, i.e. in the second assembly state of the contact hook 10 (right view in FIG. 3), the contact hook 10 is closed and lies in axial direction A within the support contour 32 on the star disk 30. In its second assembly position, the contact hook 10 does not protrude beyond the support contour 32. As a result, there is no axial loss of installation space due to the contact hook 10 and the resulting electric machine has an increased power density.

FIG. 4 shows a schematic side view of the contact arrangement 30 from FIG. 3 to explain a resistance welding process. In FIG. 4, the first resistance welding electrode 13 has already been contacted with the first contact surface 12 (see FIG. 1) of the contact hook 10 and the second resistance welding electrode 16 with the second contact surface 15 (see FIG. 1) of the contact hook 10. Subsequently, the hook portion 14 is welded to the fastening portion 12 by means of the first and second resistance welding electrodes 13 and 16 in order to produce an electrically conductive connection between the wire 18 and the contact hook 10.

One of the key factors in resistance welding is the choice of welding electrodes, as these have a major influence on the quality of the welding result. In copper welding in particular, the material only has a very low resistance, which is why the majority of the temperature comes from the electrodes.

In the case of the contact hook 10, it should be noted that heat is only desired in one region 33 of the wire 18. Therefore, two electrodes 13 and 16 with different material properties are preferably used. In particular, the first electrode 13 is preferably selected to be low impedance, e.g. made of a copper material, and the second electrode 16 is preferably selected to be high impedance, e.g. made of a tungsten material.

The locally limited thermal influence that can be achieved in this way, which the wire 18 or the welding point in the case of the contact hook 10 experiences during resistance welding, ultimately also increases its mechanical stability compared to the prior art. This can be seen in the tensile forces, wherein the tensile force of the contact hook 10 is around 100 N higher. This is particularly important when considering a mechanically stressed contact such as in a rotating rotor.

FIG. 5 shows a schematic perspective view of the rotor 40 with the contact arrangement 30 from FIG. 3. A sheet metal packet 42 with six poles is arranged on a rotor shaft 41. A star disk 31 is arranged on each axial end face of the sheet metal packet 42. The wires (not shown) of the rotor winding (also not shown) are electrically conductively connected via the respective star discs 31 to the contact hooks (not shown) attached to the star discs 31.

The invention disclosed herein enables, among other things, simplified winding with regard to wire placement by sliding the wire laterally (tolerances) into the groove of the contact hook, robust and consistent welding quality due to reliable positioning of the wire at the groove base, increased mechanical stability due to more targeted, localized heat input during resistance welding and simple fixing of the wire at the groove base after winding by bending the hook portion (e.g. by means of a punch) in order to ensure a desired welding position of the wire at the groove base in the second assembly state of the contact hook. This ensures the desired welding position of the wire at the base of the groove in the second assembly state of the contact hook.

### REFERENCE LIST

10 Contact hook
11 Fastening portion
12 First contact surface
13 First resistance welding electrode
14 Hook portion
15 Second contact surface
16 Second resistance welding electrode
17 Groove
18 Wire
19 Slot opening
20 Groove base
21 Undercut
22 Winding needle
23 Movement path
24 Wire exit angle
30 Contact arrangement
31 Star disk
32 Support contour
33 Region of high heat generation
40 Rotor
41 Rotor shaft
42 Sheet metal packet
A Axial direction
D Diameter
I Current flow
FZug Tensile force
FBew Movement force component

1. A contact hook for providing an electric contact to a winding arrangement of an electric machine, comprising
a fastening portion for fastening to the electric machine, which provides a first contact surface for a resistance welding electrode, and
a hook portion adjoining the fastening portion, which provides a second contact surface for a resistance welding electrode,
wherein the hook portion is designed and arranged to form with the fastening portion a groove for receiving a wire connected to the winding arrangement in a first assembly state, in which a free end of the hook portion forms, at a distance from the fastening portion, a groove opening for inserting the wire into the groove, wherein the free end of the hook portion in a second assembly state rests against the fastening portion, closing the groove opening, in such a way that the first contact surface and the second contact surface run plane-parallel to one another.

2. The contact hook according to claim 1, wherein the first contact surface and the second contact surface are provided on the same side of the contact hook.

3. The contact hook according to claim 1, in which the groove extends from the groove opening to a groove base inclined to the first contact surface.

4. The contact hook according to claim 1, wherein the first contact surface forms a contact surface for the wire in order to lay the wire in front of the groove opening in the first assembly state.

5. The contact hook according to claim 1, wherein the groove has a uniform diameter in the first assembly state.

6. The contact hook according to claim 1, wherein an undercut is provided in a transition region between the fastening portion and the hook portion.

7. A contract arrangement for providing an electric contact to a winding arrangement of an electric machine, comprising
a contact hook according to one of the preceding claims and
a wire connecting the contact hook to the winding arrangement.

8. A contract arrangement according to claim 7, in which the winding arrangement is a winding arrangement of a rotor of the electric machine and the contact hook is attached to a star disk of the rotor.

9. A contract arrangement according to claim 7, in which a support contour for supporting the wire is provided adjacent to the contact hook, wherein the contact hook does not project beyond the support contour in its second assembly position.

10. A method for producing a contact arrangement according to claim 7, comprising the steps of:
providing the contact hook in its first assembly state,
inserting the wire into the groove of the contact hook using a winding needle,
pulling the wire into a groove base of the groove,
producing the second assembly state of the contact hook by bending the hook portion so that the free end of the hook portion rests against the fastening portion and the first contact surface and the second contact surface run plane-parallel to one another,
contacting a first resistance welding electrode with the first contact surface,
contacting a second resistance welding electrode with the second contact surface and
resistance welding of the hook portion to the fastening portion by means of the first and second resistance welding electrodes in order to produce an electrically conductive connection between the wire and the contact hook.

11. The contact hook according to claim 2, in which the groove extends from the groove opening to a groove base inclined to the first contact surface.

12. The contact hook according to claim 2, wherein the first contact surface forms a contact surface for the wire in order to lay the wire in front of the groove opening in the first assembly state.

13. The contact hook according to claim 3, wherein the first contact surface forms a contact surface for the wire in order to lay the wire in front of the groove opening in the first assembly state.

14. The contact hook according to claim 2, wherein the groove has a uniform diameter in the first assembly state.

15. The contact hook according to claim, wherein the groove has a uniform diameter in the first assembly state.

16. The contact hook according to claim 4, wherein the groove has a uniform diameter in the first assembly state.

17. The contact hook according to claim 2, wherein an undercut is provided in a transition region between the fastening portion and the hook portion.

18. The contact hook according to claim 3, wherein an undercut is provided in a transition region between the fastening portion and the hook portion.

19. The contact hook according to claim 4, wherein an undercut is provided in a transition region between the fastening portion and the hook portion.

20. The contact hook according to claim 5, wherein an undercut is provided in a transition region between the fastening portion and the hook portion.
